(19) United States
(12) Patent Application Publication
(10) Pub. No.: US 2010/0259067 A1
(43) Pub. Date: Oct. 14, 2010

(54) Pivoting Device for a Vehicle Door

(76) Inventors: Claudia Bell, Stuttgart (DE); Jochen Bisinger, Esslingen (DE); Rainer Kristl, Wernau (DE); Jens Mueller, Stuttgart (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/682,515

(22) PCT Filed: Oct. 9, 2008
(86) PCT No.: PCT/EP08/08526

§ 371 Date: Jun. 22, 2010

(30) Foreign Application Priority Data
Oct. 10, 2007 (DE) 102007048444.7
Jan. 11, 2008 (DE) 102008003994.2

(51) Int. Cl. B60J 5/00; E05B 15/02

(52) U.S. Cl. 296/146.11; 292/341.17

(57) ABSTRACT

The invention relates to a pivoting device, by means of which a vehicle door (10), in particular a wing door, is in the normal case mounted on a body (36) of a motor vehicle and can be pivoted between an open position and a closed position, wherein the pivoting device comprises a separating device (18), by means of which the vehicle door (10) can be detached from the body in an emergency, in particular after a rollover. The invention also relates to a method for controlling a separating device (18).

The invention relates to a pivoting device, by means of which a vehicle door, in particular a wing door, is mounted on a body of a motor vehicle in the normal case and can be pivoted between an open and a closed position. The invention further relates to a method for controlling a separating device.

Such a pivoting device is for example already known from DE 33 04 660 A1 and serves for mounting a vehicle door formed as a wing door to a body of a motor vehicle. The vehicle door, which extends into a roof region of the motor vehicle and is held there by means of the pivoting device, can thereby be pivoted between an open position and a closed position by means of the pivoting device in the normal case, so as to enable entering and leaving the vehicle.

It is disadvantageous with the known pivoting device that the vehicle door can at the most be opened partially in an emergency, and in particular after a rollover of the vehicle, despite elaborate and expensive constructional measures for providing an emergency exit opening for vehicle occupants of the motor vehicle.

It is thus the object of the present invention to create a pivoting device and a method, by means of which an improved exit possibility is enabled for vehicle occupants of a motor vehicle in an emergency.

The object is solved according to the invention by a pivoting device with the characteristics of claim 1, and by a method according to claim 16.

Advantageous embodiments with convenient and non-trivial further developments are given in the respective dependent claims, wherein advantageous arrangements of the pivoting device should be viewed as advantageous arrangements of the method and vice versa.

An improved exit possibility for vehicle occupants of a motor vehicle in the case of an emergency is enabled according to the invention in that the pivoting device comprises a separating device, by means of which the vehicle door can be detached from the body in an emergency, in particular after a rollover. In other words, it is provided according to the invention that the entire vehicle door can be detached from the body for example after an accident by means of a separating device assigned to the pivoting device, and that a particularly large exit opening can be thereby provided for the vehicle occupants of the motor vehicle. It can thereby either be provided that the vehicle door can be separated from the entire pivoting device by means of the separating device, or that a part of the pivoting device remains at the body and a further part remains at the vehicle door by means of the separating device. Such a separating device can furthermore be formed very simply in a constructive manner, whereby additional cost reductions with regard to production and assembly are achieved.

In an advantageous arrangement of the invention, it is provided that the vehicle door is formed as a wing door extending into a roof region of the body and is mounted to the roof region by means of the pivoting device. In this manner, a particularly large exit opening can be provided in an emergency, which correspondingly extends into the roof region of the body. This is for example of particular advantage with a vehicle lying on one side caused by an accident.

A detaching of the vehicle door with is as problem-free as possible, in particular after a force application caused by an accident can thereby be ensured in an advantageous manner, in that the vehicle door can be pivoted around a pivot axis running essentially parallel to a longitudinal axis of the motor vehicle by means of the pivot device. A pivot device formed in such a manner or a pivot axis arranged in such a manner enables an advantageous force flow with regard to the subsequent detaching of the vehicle door with frontal and also lateral accidents.

In a further advantageous arrangement of the invention it is provided that the separating device comprises a rotary latch lock which is engaged with a striker in the normal case and which can be disengaged from the striker in an emergency for detaching the vehicle door. A separating device comprising a rotary latch lock thereby represents a constructionally simple, robust and reliable means to ensure the detachability of the vehicle in an emergency. Such a separating device enables in addition to detach the vehicle door from the body also in the in the normal case in a reversible manner, which is for example advantageous during the assembly or a servicing of the motor vehicle. By the use of the same parts, for example a rotary latch lock for an engine hood of the motor vehicle, considerable cost reductions and synergy effects can be achieved.

The available installation space can thereby be used in an optimum manner in that the rotary latch lock are fixed at the vehicle door and the striker at the body. A high mechanical stability and torsional rigidity is additionally ensured by this arrangement, so that the vehicle door can be pivoted between the open and the closed position in a reliable and operational safe manner even in the normal case,

A reliable protection against contamination and thus an efficient functionality of the separating device is ensured in a further advantageous arrangement in that the separating element is received at least partially in a housing. The separating device can additionally be formed as a preassembled unit in this manner and be assembled in a simple manner.

A positioning device is provided in a further advantageous arrangement of the invention, by means of which the separating device is positioned with regard to the pivoting device in the normal case. By means of such a positioning device, elaborate and cost-intensive adjusting measures for ensuring an efficient pivoting of the vehicle door in the normal case can be omitted during the assembly of the vehicle door. Furthermore, an efficient operability of the vehicle door during the later operation of the motor vehicle is ensured. The mentioned advantages are thereby naturally also achieved after a disassembly of the vehicle door within the scope of possible servicing work. Vice versa, such a positioning device enables a movement of the vehicle door guided at least in parts, whereby it can be detached from the motor vehicle by a predeterminable kinematics.

It has thereby been shown to be advantageous that the positioning device comprises at least one centering element, which is received in a corresponding centering reception of the housing in the normal case. This represents a constructionally simple, reliable and cost-efficient possibility to ensure the correct positioning of the separating device with regard to the pivoting device.

Further advantages result when the centering element is formed as a centering bolt and/or as a threaded sleeve. A centering element formed as a centering bolt has the advantage that, due to the longitudinal extension of the centering bolt, a guided movement of the vehicle door in parts can be accomplished during the assembly and also when detaching in an emergency. A centering element formed as a threaded sleeve additionally permits a securing of screw connections in addition to a simplified positioning of the vehicle door and enables thereby an advantageous integration of several functions in one component.

A detaching of the vehicle door by an external force is enabled in an advantageous manner in that the separating device comprises an electrical and/or pneumatic and/or hydraulic and/or pyrotechnical and/or mechanical actuator, by means of which the vehicle door can be detached from the body in an emergency. The actuator can thereby be formed for example as a hand force lever, percussion cap, hydraulic adjuster, pneumatic adjusterb or electric motor in dependence on the given circumstances. The fundamental boundary conditions for detaching the vehicle door such as fast and secure release or a high one-time force requirement have to be considered thereby.

In a further advantageous arrangement of the invention, it is provided that the actuator is arranged and designed in the region of a catch of the rotary latch lock of the separating device, to actuate the catch in an emergency for detaching the vehicle door. This represents a constructionally simple and cost-efficient possibility to reliably fulfill the above-mentioned boundary conditions. It can thereby further be provided that the actuator is supported on a housing of the rotary latch lock or the separating device or integrated therein at least partially. A reliable force application of the catch is hereby ensured during the actuating of the actuator. The rotary latch lock or the separating device can additionally be manufactured as a module which can be built in or exchanged in a simple and fast manner, further cost advantages result hereby.

A reliable detaching of the vehicle door is ensured in a further arrangement in that the separating device is coupled to a sensor unit, in particular a crash sensor, wherein the emergency shall be detected by means of the sensor unit and a control signal characterizing the emergency shall be transferred to the separating device, wherein the separating device shall be controlled in dependence on the control signal. In other words, the separating device is formed in such a manner that it detaches the vehicle door from the body without manual intervention, if a crash sensor coupled thereto signals the presence of an emergency. A problem-free access from the outside into the interior passenger space can be ensured thereby. The coupling can thereby be effected directly and also via a bus system, known per se, wherein for example an airbag sensor, a delay sensor or other sensor units known to the expert can be provided.

It has thereby further been shown to be advantageous that the sensor unit is formed as a rotational speed sensor and/or as a statical z sensor and/or as a rollover sensor and/or as a Low-G-acceleration sensor and/or as a tilting cone sensor. A critical diagonal position of the vehicle and thus the presence of the emergency can be detected reliably with the help of one or several of the mentioned sensor types, so that the separating device can be accessed in a particularly precise manner. Conversely, a faulty and undesired release of the separating device is safely excluded in the normal case. 22°, 57° or 64° versions are for example suitable as tilting cone sensors, however, alternative sensor tyoes are also conceivable. The most advantageous sensor type for the respective installation situation can thereby preferably be chosen in dependence on the parameters diagnostics, reliability, costs, installation space and interface connection.

It is provided in a further advantageous arrangement of the invention that a spring element, in particular a gas pressure spring element is assigned to the pivoting device, by means of which the vehicle door can be charged with a spring force with regard to the body. This enables a spring force detaching of the vehicle door from the body in the normal case. In addition, a comfortable, spring force-supported pivoting of the vehicle door can be ensured in the normal case.

So as to also ensure a reliable pivoting of the vehicle door even in the normal case, it is provided in a further arrangement that a lever element is assigned to the separating device, by means of which lever element the separating device is supported at the pivoting device at least in parts. With the help of such a lever element, torques occurring during the pivoting of the vehicle door can be transferred and distributed in a more even manner. Such a lever element further enables to fix the separating device in a certain position in the normal case.

A further aspect of the invention relates to a method of controlling a separating device, by means of which a vehicle door mounted pivotable between an open position and a closed position at the body of a vehicle, in particular a wing door, can be detached from the body, in particular after a rollover, wherein the method comprises the steps a) checking if the emergency is present and b) detaching the vehicle door (10) from the body (36), if the emergency checked in step a) is present. The method according to the invention thereby enables an improved exit possibility for vehicle occupants of a motor vehicle in contrast to the state of the art in an emergency, in which the entire vehicle door is detached from the body. Further advantages are already known from the previous descriptions of advantages.

It has thereby been shown to be advantageous that the checking according to step a) is carried out while considering a control signal of a crash sensor by means of which at least the emergency shall be detected. A particularly reliable check of the presence of an emergency can be carried out while considering a control signal of a crash sensor which is usually present in any case, irrespective of a corresponding lowering of the manufacture costs.

So as to detach the vehicle door from the body supported with an external force, it is provided in a further arrangement of the invention that the detaching of the vehicle door according to step b) is carried out by accessing an associated actuator of the separating device.

It has thereby been shown to be furthermore advantageous that a functional check of the actuator of the separating unit is carried out when starting an engine of the motor vehicle. A fundamental operational readiness of the actuator can be checked and ensured in this manner, so that the safety increment is ensured in a reliable manner even after an operation for several years. The functional check of the actuator can thereby be carried out with each engine start of the motor vehicle in the most simple case. Other check cycles can however also be provided.

In order to avoid an insufficient detachment of the vehicle door from the body, it is provided in a further advantageous arrangement of the invention that the vehicle door in step b) is only detached if a vehicle door lock associated with the vehicle door is also opened. It is ensured in this manner that the vehicle door is detached in the region of the pivoting device and also in the region of a vehicle door lock usually opposite of the pivoting device and can correspondingly be moved freely. For determining if the vehicle door lock is opened or is already opened, a control signal of a switch associated with the vehicle door lock can be considered for example. The actuation of the vehicle door lock itself can fundamentally be effected by means of a manual outer or inner actuation lever or by means of an externally actuable actuator.

Further advantages, characteristics and details of the invention result from the following descriptions of embodiments and by means of the drawings, in which the same elements or element having the same functionality are provided with identical reference numerals. It shows thereby:

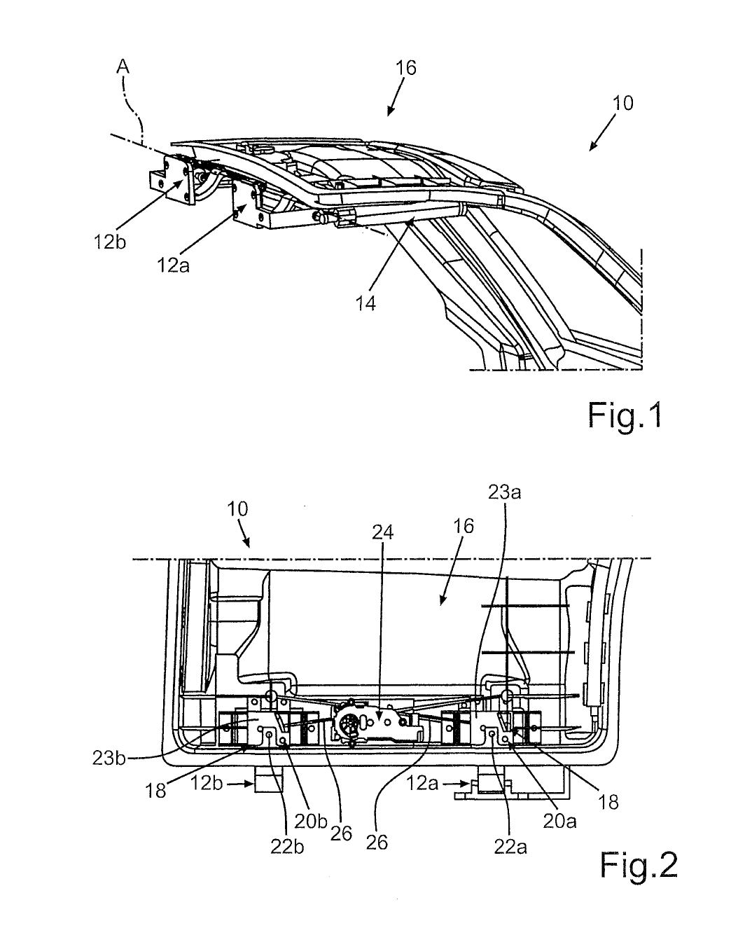

FIG. 1 a lateral and perspective partial view of a vehicle formed as a wing door, which is connected to a pivoting device according to an embodiment;

FIG. 2 an inner side of a roof region of the vehicle door according to fig, in a bottom view;

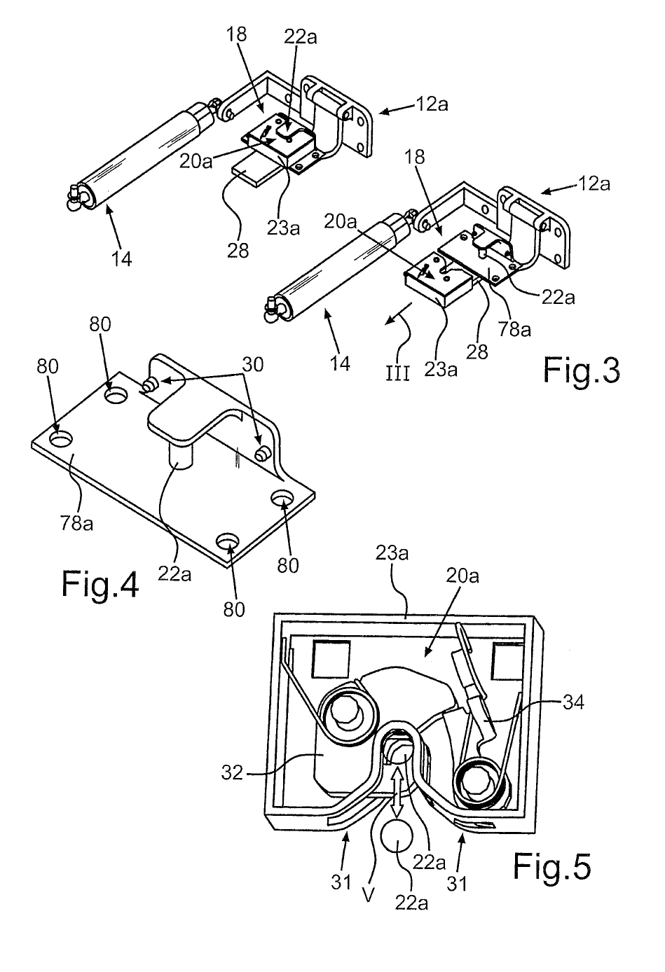

FIG. 3 simplified perspectives of the pivoting device shown in FIG. 1 and FIG. 2 in the normal case and in an emergency;

FIG. 4 a perspective of a striker according to FIG. 3 with two centering bolts;

FIG. 5 a perspective top view of a rotary latch lock of the separating device received in a housing;

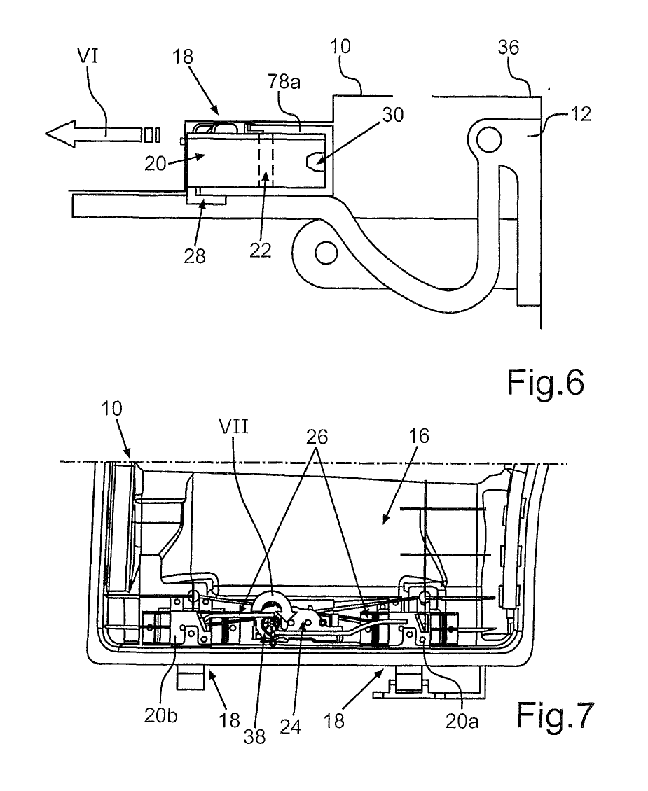

FIG. 6 a schematic lateral sectional view of a pivoting device according to a further embodiment;

FIG. 7 the inner side of the roof region of the vehicle door according to FIG. 2 in a bottom view, wherein a functional test of an actuator assigned to the separating device is carried out;

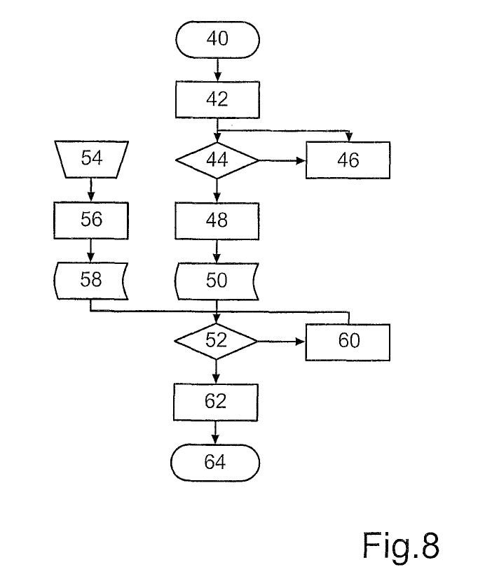

FIG. 8 a flow diagram of a control logic for the separating device;

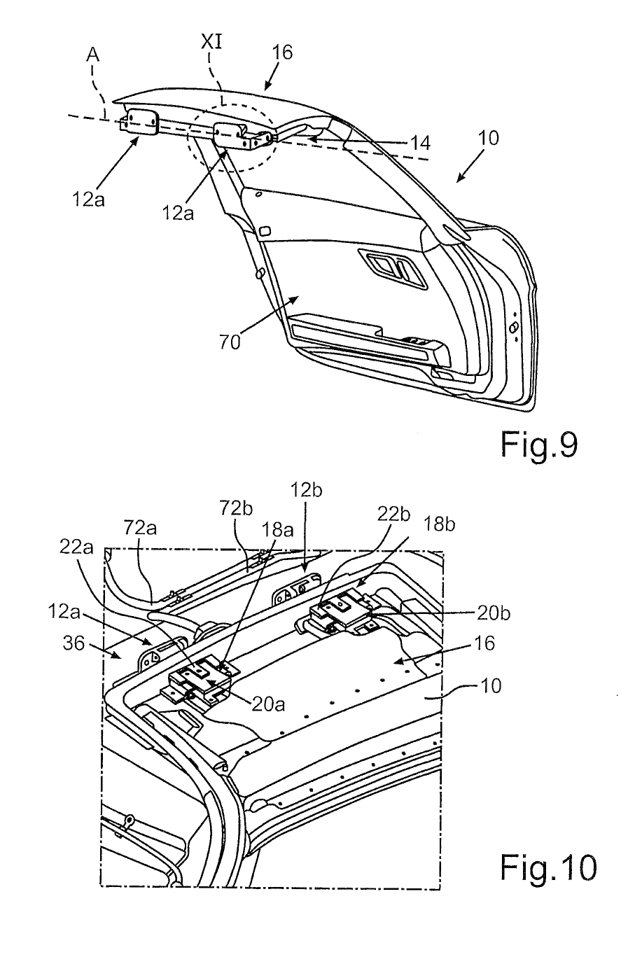

FIG. 9 a lateral and perspective rear view of a vehicle door formed as a wing door according to a further embodiment;

FIG. 10 a perspective top view and in parts of the vehicle door shown in FIG. 9 and connected to a body shell structure of a motor vehicle;

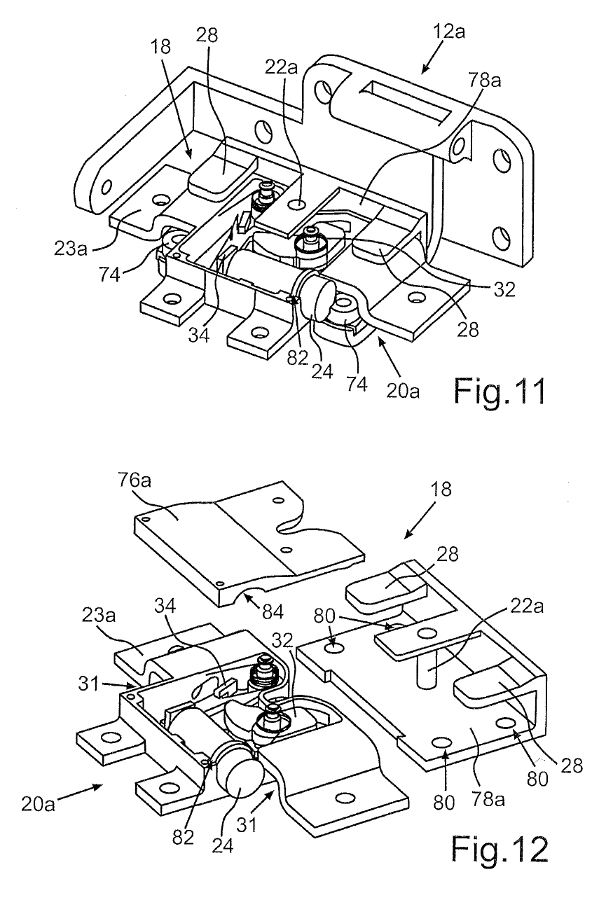

FIG. 11 a schematic and perspective diagonal view of a pivoting device shown in FIG. 9 and FIG. 10;

FIG. 12 a schematic perspective of a separating device of the pivoting device shown in FIG. 11; and

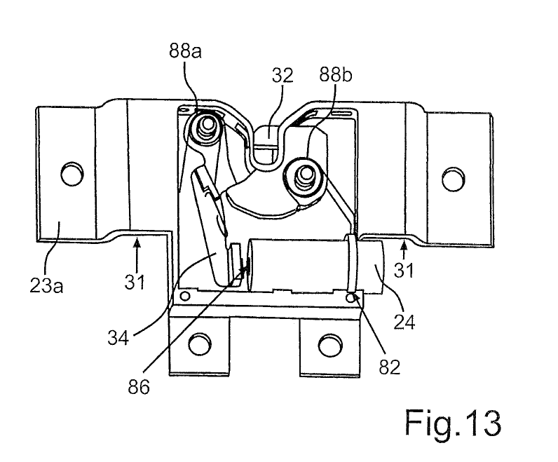

FIG. 13 a schematic top view of a housing of the separating device shown in FIG. 12.

FIG. 1 shows a lateral and perspective partial depiction of a vehicle door 10 formed as a wing door, which is connected to a pivoting device according to an embodiment. Two hinges 12a, 12b can thereby be seen from the pivoting device, by means of which hinges the pivoting device can be fixed to a body 36 (see FIG. 6) of a motor vehicle. The vehicle door 10 thereby extends to a roof region of the body 36 in the fixed state and can be pivoted between an open and a closed position by means of the pivoting device around a pivot axis A running essentially parallel to a longitudinal axis of the motor vehicle. A gas pressure spring element 14 is thereby assigned to a hinge 12a of the pivoting device, which spring element is arranged laterally at a roof region 16 of the vehicle door 10, and by means of which the vehicle door 10 can be charged with a spring force with regard to the body 36. Thereby, several gas pressure springs 14 can naturally also be provided in an alternative manner.

FIG. 2 shows the inner side of the roof region 16 of the vehicle door 10 according to FIG. 1 in a bottom view. The separating devices 18 can particularly be seen thereby, which are assigned to the hinges 12a, 12b of the pivoting device. The separating device 18 comprises two rotary latch locks 20a, 20b, which are fixed to the roof region 16 of the vehicle door 10 and are engaged with corresponding strikers 22a, 22b of the pivoting device in the normal case (see FIG. 3). The strikers 22a, 22b are thereby carried by respectively associated striker carriers 758a, 78b. The rotary latch locks 20a, 20b are themselves received in associated housings 23a, 23b. It can thereby alternative also be provided that the separating device 18 or the rotary latch locks 20a, 20b are arranged fixed on the body and the strikers 22a, 22b fixed on the vehicle door. For detaching the vehicle door 10 from the body 36, the rotary latch locks 20a, 20b are disengaged from their respective strikers 22a, 22b in an emergency, whereby the vehicle door 10 is removed completely from the body 36, and a correspondingly large exit opening can be cleared for vehicle occupants.

The detaching of the vehicle door 10 by means of the separating device 18 or the opening of the rotary latch locks 20a, 20b is triggered with the help of an actuator 24 presently formed as an electric motor, which actuator is connected to the rotary latch locks 20a, 20b via coupling means 26. The coupling means 26 are thereby formed as Bowden cables in the shown embodiment, but they can also comprise control rods (see FIG. 7) or the like. Pneumatic, hydraulic, mechanical or pyrotechnical actuators 24 can also be used instead of an electric motor, wherein, with a position of the pivoting device in the head region of a vehicle occupant shown presently, pyrotechnical actuators have not been shown to be advantageous due to the danger of a splitter formation.

FIG. 3 shows simplified perspectives of the pivoting device in a normal case shown in FIG. 1 and FIG. 2, in which the vehicle door 10 (not shown) fixed at the rotary latch lock 20a of the separating device 18 is mounted pivotably at the body 36 of the motor vehicle, and in an emergency, kin which the vehicle door 10 is detached from the body 36 by means of the separating device 18. The rotary latch lock 20a is engaged with the the striker 12a fixed to the body in the normal case, which is fixed to the hinge 12a fixed on the body of the pivoting device. In an emergency, the rotary latch lock 20a is disengaged from the striker 22a with the help of an associated of an associated actuator 24, whereby the vehicle door 10 can be removed from the body 36 and along the lever element 28 formed as a guiding plate according to the arrow III. The detaching of the vehicle door 10 is thereby supported by the spring force of the gas pressure spring element 14. It can thereby also be provided that the gas pressure spring element 14 can be divided or removed from the vehicle door 10.

FIG. 4 shows a perspective of the striker 22a according to FIG. 3, wherein two centering bolts formed in particular in one part woth the striker carrier 78a and serving as centering elements can be seen, which are received in the normal case in corresponding centering centering receptions 31 (see FIG. 5) of the housing of the rotary latch lock 20a and thereby position the separating device 18 with regard to the pivoting device. Furthermore, several assembly openings 80 of the strike carrier 78a can be seen, via which this can be connected to the hinge 12a.

FIG. 5 shows a perspective top view of the rotary latch lock 20 of the separating device 18 received in the housing 23a, wherein a lid of the housing 23a is not shown. The rotary latch lock 20a has a construction known from the state of the art with a rotary latch 32 and a catch 34. The striker 22a previously in engagement with the rotary latch 32 is released in an emergency by actuating the catch 34, and can thereby be disengaged from the rotary latch lock 20a along the arrow V. The actuation of the catch 34 can take place with the help of an actuator 24, as already mentioned. A bonnet lock can for example be used as a rotary lock latch 20a, whereby the separating device 18 can be represented in a cost-efficient manner.

FIG. 6 shows a schematic laterall sectional view of a pivoting device according to a further embodiment. The general construction is thereby already known from the previous descriptions. The striker 22 is also fastened to the body via the hinge 12 of the pivoting device in the present embodiment, while the rotary latch lock 20 of the separating device 18 is fixed at the vehicle door 10. In contrast to the previous embodiment, the carrier plate of the striker 22 is inserted into the hook-shaped lever element 28, whereby an improved torque transfer is achieved. After detaching the vehicle door 10 by means of the separating device 18, the vehicle door 10 can be removed from the body 36 along the arrow VI.

FIG. 7 shows the inner side of the roof region 16 of the vehicle door 10 according to FIG. 2 in a bottom view. The coupling means 26 formed as Bowden cables drives the actuator 24 for detaching the vehicle door 10 in an emergency via a rope pulley 38, by means of which coupling means the catches 34 of the rotary latch locks 20a, 20b are finally actuated. The rope pulley 38 thereby has to be moved clockwise in the present embodiment according to the arrow VII to dteach the vehicle door 10. As actuators 24 possibly may not start reliably after years of not being functional, a functional check of the actuator 24 assigned to the separating device is carried out with each start of the engine of the motor vehicle, by moving the rope pulley 38 first counterclockwise and then clockwise until reaching the starting position. The actuator or the separating device 18 is coupled to an engine control device of the motor vehicle for this for example directly or via a bus system.

FIG. 8 shows a flow diagram of a control logic for the separating device 18, which is coupled to a crash sensor (not shown) of the motor vehicle, by means of which the emergency shall be signalled. The actuator 24 can thereby be accessed when an emergency is recognized for example by powering it and transmit a detaching of the vehicle door 10 in an already described manner.

If the emergency 40 is present after an accident of the motor vehicle, which is for example in a roof position, this is detected by means of the crash sensor in step 42 and a corresponding xcontrol signal is generated. In step 44 it is checked subsequently if the crash sensor still emits the control signal even after a predetermined time, e.g. after 3 seconds. It can be ensured thereby that the motor vehicle remains in the roof position and the emergency 40 is present continuously. If the crash sensor does not send a corresponding control signal any longer, it is assumed that the emergency 40 is not present or is no longer present and that the method can be ended in step 46. If the crash sensor however further sends the signal characterizing the emergency 40, this control signal is stored in step 50 in a storage unit by means of a associated control unit. In order to avoid an only partial detachment of the vehicle door 10 in the region of the pivoting device, it is checked in step 10 if the vehicle door lock of the vehicle door 10 is also open. For this, a microswitch checks in step 56 after an manual actuation 54 of an outer or inner actuation lever of the vehicle door, if the vehicle door lock is released and sends a corresponding control to the control unit, which this also stores in the storage unit. If the check in step 52 results in that only one of the two necessary control signals is present, the method is ended in step 60. Alternatively, a new cycle can also be carried out. If it is determined in step 52 that both control signals are present in the storage unit, the actuator 24 of the separating device 18 is powered in step 62, whereby the the vehicle door 10 is detached from the body 36 and can finally be removed manually or supported by a spring force, to release the exit opening.

FIG. 9 shows a lateral and perspective rear view of a vehicle door 10 formed as a wing door and connected to a pivoting device according to a further embodiment. The two hinges 12a, 12b can again be seen from the pivoting device, via which the pivoting device can be fixed at a body 36 (see FIG. 10) of a motor vehicle. The vehicle door 10, whose principal construction can already be taken from the previous descriptions, thereby also forms a roof region 16 of the body 36 in the fixed state and can, as in the previous embodiment, be pivoted between the open and the closed position around the pivot axis A running essentially parallel to the longitudinal axis of the motor vehicle by means of the pivoting device. The vehicle door 10 is presently shown in an upgraded state and comprises amongst other an inner door panel 70 and comfort elements covered by the inner door panel 70, as for example central locking, electrical window lifts and the like. An overview of advantageous assembly versions of such vehicle doors 10 is given in the following table.

TABLE
Assembly versions of the vehicle door 10:

| | Version 1 | Version 2 | Version 3 |
|---|---|---|---|
| Bodyshell | The checked | The checked | The hinge and the |
| | pivoting device is | pivoting device is | dummy module |
| | built in; the | built in; the | are built in; the |
| | vehicle door 10 is | vehicle door 10 is | vehicle door 10 is |
| | connected. | connected. | connected. |
| KTL, | The hinge 12 and | The hinge 12 and | The hinge 12 and |
| coating | the separating | the separating | the dummy |
| | device 18 remain | device 18 remain | module remain at |
| | at the motor | at the motor | the motor vehicle. |
| | vehicle. | vehicle. | |
| Door | The vehicle door | The vehicle door | The vehicle door |
| upgrade | is knocked off; | is knocked off; the | is knocked off; the |
| | the separating | separating device | dummy module is |
| | device 18 remains | 18 is detached | removed, the |
| | at hinge 12. | from the hinge 12. | separating device |
| | | | 18 is applied. |
| Assembly | The upgraded | The upgraded | The upgraded |
| | vehicle door 10 is | vehicle door 10 is | vehicle door 10 is |
| | positioned at the | positioned at the | positioned at the |
| | motor vehicle and | motor vehicle and | motor vehicle |
| | is assembled. | is assembled; a | possibly by an |
| | | centering is not | alignment edge |
| | | necessary | and is assembled |

FIG. 10 shows a perspective top view and in parts of the vehicle door 10 shown in FIG. 9, which is fixed to the body 36 shown in the bodyshell state via the pivoting device. Especially cable strands 72a, 72b can be seen thereby, via which the actuators 84 of the respective separating devices 18 are also supplied with electrical energy in addition to the mentioned comfort elements.

FIG. 11 schematically shows a perspective diagonal view of the pivoting device shown in FIG. 9 and FIG. 10. The striker carrier 78a carrying the striker 22a can be seen at the hinge 12a of the pivoting device, which carrier comprises two lever elements 28 formed as guide plates in the present embodiment, which lever elements cooperate with the housing 23a of the separating device 18. The housing 23a of the separating device 18 comprising the rotary latch lock 20a, which is shown without the housing lid for clarity (see FIG. 12), comprises a pyrotechnical actuator in the present embodiment, which is arranged in the region of the catch 34 and can actuate this in an emergency, so as to disengage the striker 22a from the rotary latch 32. The elongated actuator 24 is thereby countersunk in a groove 82 of the housing 23a in sections in a form-fit manner, and arranged mainly within the housing 23a. The striker carrier 78a is screwed to the hinge 12a via several screws (not shown) which are guided through the assembly openings 80, wherein the screws are countered with the help of threaded sleeves 74 serving as centering element. The housing 23a comprises lateral centering receptions 31 for this (see FIG. 12), in which the threaded sleeves 74 are arranged in the normal case. The housing 23a can thus be moved along the round outer contours of the threaded sleeves 74, wherein a positioning of the separating device 18 and a guide during the assembly and during the detaching of the vehicle door 10 is achieved during the cooperation with the lever elements 28.

FIG. 12 shows the schematic perspective of the separating device 18 of the pivoting device shown in FIG. 11. The housing lid 76a of the housing 23a can in particular be seen thereby. The housing lid 76a is formed in the shape of a wedge in parts in its cross section to cooperate with the lever elements 28 of the striker carrier 27a. The housing lid 76a further comprises a recess 84 for receiving the actuator 24.

FIG. 13 shows a schematic top view of the housing 23a of the separating device 18 shown in FIG. 12. An actuating bolt 86 of the pyrotechnical actuator 24 formed as a so-called “pinpusher” can thereby especially be seen, which deflects the catch 34 against the spring force of the spring element 88a when releasing the acuator 24, so as to release the rotary latch 32.

1. Pivoting device, by means of which a vehicle door (10), in particular a wing door, is in the normal case mounted on a body (36) of a motor vehicle and can be pivoted between an open position and a closed position,
characterized in that
the pivoting device comprises a separating device (18), by means of which the vehicle door (10) can be detached from the body in an emergency, in particular after a rollover.

2. Pivoting device according to claim 1,
characterized in that
the vehicle door (10) is formed as a wing door extending into the roof region of the body (36) and is mounted to the roof region by means of the pivoting device.

2. Pivoting device according to claim 1 or 2,
characterized in that
the the vehicle door (10) can be pivoted around a pivot axis (A) running essentially parallel to a longitudinal axis of the motor vehicle by means of the pivoting device.

4. Pivoting device according to one of claims 1 to 3,
characterized in that
the separating device (18) comprises a rotary latch lock (20a, 20b), which is engaged with a striker (22a, 22b) in the normal case and which can be disengaged from the striker (22a, 22b) in an emergency for detaching the vehicle door (10).

5. Pivoting device according to claim 4,
characterized in that
the rotary latch lock (20a, 20b) is fixed at the vehicle door (10) and the striker (22a, 22b) at the body (36).

6. Pivoting device according to one of claims 1 to 5,
characterized in that
the separating device (18) is received at least partially in a housing (23a, 23b).

7. Pivoting device according to one of claims 1 to 6,
characterized in that
a positioning device is provided, by means of which the separating element (18) is supported at the pivoting device at least in the normal case.

8. Pivoting device according to claims 6 and 7,
characterized in that
the positioning device comprises at least one centering element, which is received in a corresponding centering reception (31) of the housing (23) in the normal case.

9. Pivoting device according to claim 8,
characterized in that
the centering element is formed as a centering bolt (30) and/or as a threaded sleeve (74).

10. Pivoting device according to one of claims 1 to 9,
characterized in that
the separating device (18) comprises an electrical and/or pneumatic and/or hydraulic and/or pyrotechnical and/or mechanical actuator (24), by means of which the vehicle door (10) can be detached from the body in an emergency.

11. Pivoting device according to claims 4 or 5 and 10,
characterized in that
the actuator (24) is arranged in the region of a catch (34) of the rotary latch lock (20a, 20b) and is designed to actuate the catch (34) in an emergency for detaching the vehicle door (10).

12. Pivoting device according to one of claims 1 to 11,
characterized in that
the separating device (18) is coupled to a sensor unit, in particular a crash sensor, by means of which the emergency shall be detected and a control signal characterizing the emergency be transferred to the separating device (18), wherein the separating device (18) shall be controlled in dependence on the control signal.

13. Pivoting device according to claim 12,
characterized in that
the sensor unit is formed as a rotational speed sensor and/or as a statical z sensor and/or as a rollover sensor and/or as a Low-G-acceleration sensor and/or as a tilting cone sensor.

14. Pivoting device according to one of claims 1 to 13,
characterized in that
a spring element is assigned to the pivoting device, in particular a gas pressure spring element (14), by means of which the vehicle door (10) can be acted upon with a spring force with regard to the body (36).

15. Pivoting device according to one of claims 1 to 14,
characterized in that a lever element (28) is assigned to the separating device (18), by means of which lever element the separating element (18) is supported at the pivoting device at least in the normal case.

16. Method for controlling a separating device (18), by means of which a vehicle door (10), which is mounted on a body (36) of a motor vehicle in the normal case, can be pivoted between an open position and a closed position by means of a pivoting device, in particular a wing door, can be detached from the body (36) in an emergency, in particular after a rollover, with the following steps:
a) checking if the emergency is present; and
b) detaching the vehicle door (10) from the body (36), if the emergency checked in step a) is present.

17. Method according to claim 16,
characterized in that
the checking according to step a) is carried out while taking a control signal of a crash sensor into account, by means of which at least the emergency shall be detected.

18. Method according to claim 16 or 17,
characterized in that
the detaching of the vehicle door (10) according to step b) is carried out by accessing an associated actuator (24) of the separating device.

19. Method according to claim 18,
characterized in that
a functional check of the actuator (24) of the separating device (18) is preferably carried out during the start-up of an engine of the motor vehicle.

20. Method according to one of claims 16 to 19,
characterized in that
the vehicle door (10) in step b) is only detached if a vehicle door lock associated with the vehicle door (10) is also opened.
